(19) United States
(12) Patent Application Publication
(10) Pub. No.: US 2019/0239528 A1
(43) Pub. Date: Aug. 8, 2019

(54) EMULSION INCLUDING ANTIOXIDANTS

(71) Applicant: CARGILL, INCORPORATED, WAYZATA, MN (US)

(72) Inventors: Zhaolin HAO, Beijing (CN); Zhukun MA, Tianchang (CN); Weilin XUE, Nantong (CN)

(21) Appl. No.: 16/113,270

(22) Filed: Aug. 27, 2018

Related U.S. Application Data
(60) Provisional application No. 62/640,664, filed on Mar. 9, 2018.

(30) Foreign Application Priority Data
Feb. 6, 2018 (CN) 201810116784.2

(51) Int. Cl. A23D 7/005; A23L 33/105; A23L 33/115; A23L 33/15; A23L 35/00

(52) U.S. Cl. CPC A23D 7/0056; A23L 33/105; A23L 33/115; A23L 33/15; A23L 35/10; A23V 2250/032; A23V 2200/02; A23V 2200/15; A23V 2200/222; A23V 2250/21; A23V 2250/708; A23V 2002/00

(57) ABSTRACT

Various embodiments disclosed relate to oil and water emulsions including antioxidants. The emulsion can include an oil-phase; an aqueous-phase; an extract including carnosic acid, carnosol, or a mixture thereof; an extract containing rosmarinic acid; and an emulsifier.

### CROSS REFERENCE TO RELATED APPLICATION

This application claims the benefit of U.S. Provisional Patent Application, Ser. No. 62/640,664, filed Mar. 09, 2018, entitled EMULSION INCLUDING ANTIOXIDANTS, and Chinese Patent Application Serial No. 201810116784.2, filed Feb. 06, 2018, entitled EMULSION INCLUDING ANTIOXIDANTS, which applications are hereby incorporated by reference in its entirety.

### BACKGROUND

Edible oil and water emulsions are an increasingly important dietary staple. As immiscible liquids, oil and water form separate phases when mixed. In an emulsion, mechanical or chemical force disperses one phase into the other. Oil and water emulsions can readily provide otherwise difficult-to-achieve culinary textures, for example, a smooth and creamy mouthfeel. By varying the relative amount of oil and water, the resulting emulsion may take a variety of forms, such as margarine, shortening, dips, spreads, cream, milk, or salad dressings.

Oxidation of some oil and water emulsions can result in unpleasant flavors and rancidification. Levels of oxidation can be described using peroxide value (PV), which can describe current oxidative activity, and p-anisidine value (AV), which can describe historic or total oxidative activity. Oils are susceptible to oxidation due to the presence of double bonds in the fatty acid chain of fats. Oils having a greater number of double bonds, or greater degree of unsaturation, are generally more susceptible to oxidation. For a variety of reasons, including variation in oxidation pathways and the chemical and physical properties of substrates, antioxidants which are useful for one food type (e.g., protein) are not necessarily useful for others (e.g., fats). Synthetic antioxidants such as butylated hydroxyanisole (BHA), butylated hydroxytoluene (BHT), tert-butylhydroquinone (TBHQ) and propyl gallate (PG) are commonly used to reduce oxidation in food products.

### SUMMARY OF THE DISCLOSURE

The present disclosure provides an emulsion including an oil-phase; an aqueous-phase; an extract including carnosic acid, carnosol, or a mixture thereof; a spearmint extract; and an emulsifier.

The present disclosure further provides an emulsion including an oil-phase that is about 80 wt % to about 87 wt % of the emulsion. The oil-phase has an edible oil; an emulsifier, which is about 0.1 wt % to about 0.5 wt % of the oil-phase; and an oil-soluble extract comprising carnosic acid, carnosol, or a mixture thereof, which is about 0.005 wt % to about 0.04 wt % of the oil-phase. The emulsion also includes an aqueous-phase which has water; citric acid, which is about 0.005 wt % to about 0.05 wt % of the aqueous-phase; and ascorbic acid, or a salt thereof, which is about 0.005 wt % to about 0.05 wt % of the aqueous-phase.

The present disclosure also provides an emulsion that is margarine, wherein the emulsion includes an oil-phase having an edible oil; an aqueous-phase having water; carnosic acid, carnosol, or a mixture thereof; rosmarinic acid; and an emulsifier.

Advantages, some of which are unexpected, are achieved by some of the emulsions and methods of the present disclosure. For example, various embodiments of the emulsion of the present invention have the advantage of longer shelf life, such as compared to oil and water emulsions which do not contain both a spearmint extract and an extract including carnosic acid, carnosol, or a mixture thereof. The shelf life of some embodiments of the emulsion is, advantageously, at least 12 months or at least 24 months. Various embodiments of the emulsion show improved stability towards oxidation, such as compared to oil and water emulsions which do not contain both a spearmint extract and an extract including carnosic acid, carnosol, or a mixture thereof.

Some embodiments of the emulsion have the advantage of providing an emulsion that is stable to oxidation without use of butylated hydroxyanisole (BHA), butylated hydroxytoluene (BHT), tert-butylhydroquinone (TBHQ), propyl gallate (PG) or other synthetic antioxidants.

Various embodiments of the emulsion have the advantage wherein any antioxidants in the emulsion are plant-derived antioxidants. Some such emulsions may have the advantage of being all-natural. Some embodiments of the emulsion have the advantage of a limited list of ingredients, such that no more than 12, 11, 10, 9 8, 7, 6, 5 or 4 ingredients need be listed on product labels.

Advantageously, some embodiments of the emulsion include spearmint extract at an amount less than 0.0001 wt % of the emulsion, but result in greater oxidative stability than other emulsions including the same amount of spearmint extract. Some embodiments of the emulsion include an extract having carnosic acid, carnosol, or a mixture thereof at amount less than 0.002 wt % of the emulsion, but result in greater oxidative stability than other emulsions including the same amount of the extract having carnosic acid, carnosol, or a mixture thereof. Some embodiments of the emulsion show a more than additive beneficial effect on oxidative stability from the combination of ingredients. Some embodiments show a synergistic beneficial effect from some of the combined ingredients.

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Any publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “room temperature” as used herein refers to a temperature of about 15 ° C. to 28° C.

The term “solid” as used herein refers to a substance being in the solid phase at room temperature and ambient pressure (i.e., approximately 1 atm). A solid has a defined shape.

The term “liquid” as used herein refers to a substance being in the liquid phase at room temperature and ambient pressure (i.e., approximately 1 atm). A liquid is fluid and conforms to the shape of its container.

The term “semi-solid” as used herein refers to a substance being in a phase which lies between a solid and a liquid or shares some qualities of a solid and some qualities of a liquid. Solid Fat Index (SFI) may be measured using a dilatometer or by using differential scanning calorimetry (DSC), by techniques well known to a person of ordinary skill in the art.

Percent fat may be measured by, e.g., the method prescribed in “Official Methods of Analysis of the Associate of Official Analytical Chemists,” 13^{th} Ed. (1980), section 16.206, “Indirect Method,” under the heading “Fat [47]—Official Final Action”, which is incorporated herewith by reference.

Peroxide Value (PV) may be determined using ISO3960/1994, which is hereby incorporated by reference, or by other art recognized means. The peroxide value corresponds to the quantity of those substances in the sample, expressed in terms of active oxygen, that oxidize potassium iodide. The peroxide value may be expressed in milliequivalents (meq) of active oxygen per kilogram of oil, but it may also be expressed (in SI units) as millimoles (mmol) of active oxygen per kilogram of oil. The value expressed in millimoles of active oxygen per kilogram is half that expressed in milliequivalents of active oxygen per kilogram. Peroxide Value (PV) may also be determined using China Regulation GB5009.227-2016, which is hereby incorporated by reference.

The p-anisidine value (AV) may be determined using International Organization for Standardization method ISO6885/1994, which is hereby incorporated by reference, or by other art recognized means. The anisidine value corresponds to one hundred times the increase in absorbance, measured at a wavelength of 350 nm in a 10 mm cell, of a test solution when reacted with p-anisidine under the test conditions. The anisidine value has no dimensions, and is calculated and quoted on the basis of 1 g of the test sample in 100 ml of a mixture of solvent and reagent

As used herein, the term “edible oil” means an oil suitable for human consumption. Edible oils are typically compositions including triacylglycerols. Edible oils can be hydrogenated oils, chemically or enzymatically interesterified oils, fractionated oils, and blended oils. The edible oil may be an identity-preserved oil or a genetically-modified oil. The process of hydrogenation of oils refers to the partial or complete saturation of the fatty acid components of triacylglycerols. Interesterification refers to a process where fatty acids have been rearranged on the glycerol backbone of a triacylglycerol. Fractionation refers to a process where one fraction of an oil is separated from another fraction. Typically, using temperature modification, an oil can be separated into lower and higher melting point fractions. Blending refers to a process where one or more different oils or oil fractions are mixed together.

These above-described processes can be carried out to provide an edible oil with the desired characteristics to be used in a particular application (e.g., baking, frying). More than one of these processes can be carried out to provide such an edible oil. For example, oils can be blended followed by interesterification to yield a useful edible oil. The present disclosure contemplates combinations of any of the above-described oils can be used.

Edible oils may include, without limitation, a citrus oil (e.g., lemon oil, orange oil), a coconut oil, a corn oil, a cottonseed oil, a flax seed oil, a grape seed oil, a marine oil (e.g., a fish oil, an algal oil, a fungal oil), a mustard oil, a nut oil (e.g., almond oil, cashew oil, walnut oil), an olive oil, a palm oil (and fractions), a peanut oil, a rapeseed oil (e.g., a canola oil), a rice bran oil, a safflower oil, a sesame oil, a soybean oil, a sunflower oil, or mixtures thereof.

The edible oil may include one or more omega-3 fatty acids, such as, for example, alpha-linolenic acid (“ALA”), docosahexaenoic acid (“DHA”), eicosapentaenoic acid (“EPA”), and stearidonic acid (“SDA”). The edible oil may also include one or more omega-6 fatty acids, such as, for example gamma-linolenic acid, linoleic acid, dihomo-gamma-linolenic acid, arachidonic acid, and combinations thereof.

The edible oil may be a refined oil. The term “refined oil” refers to a vegetable oil which has undergone a refining process. Refining is a process in which unwanted constituents are removed from an oil. Oils can be refined to varying degrees, and it is the desired quality of the refined oil which determines the degree of refining. Additionally, depending upon the properties of the oil desired, different processing steps can be included. Processes of refining oils are well known in the art; an exemplary description of a refining process is provided in Perkins et al., Deep Frying: Chemistry, Nutrition, and Practical Applications, pp. 12-24, AOCS Press, 1996.

### Emulsion

The present disclosure provides an emulsion including an oil-phase; an aqueous-phase; an extract including carnosic acid, carnosol, or a mixture thereof; a spearmint extract; and an emulsifier. The emulsion can be any suitable emulsion. The emulsion may be an edible emulsion. The emulsion may be a margarine, a cream, a spread, a dip, a dressing, a shortening, a milk or a sauce. In a specific embodiment, the emulsion is margarine.

The present disclosure also provides a margarine emulsion including: an oil-phase having an edible oil; an aqueous-phase including water; carnosic acid, carnosol, or a mixture thereof; rosmarinic acid; and an emulsifier.

The emulsion of the subject disclosure may, at room temperature and standard pressure, be solid, semi-solid or liquid. The emulsion may be in the form of a bar, a stick, a soft stick or a soft spreadable mixture in a tub or other container. The emulsion can be spreadable at room temperature or spreadable at refrigeration temperatures. The emulsion may be a liquid which may be squirted or poured.

According to some examples and embodiments of the present disclosure, an emulsion includes an oil-phase and an aqueous-phase, wherein one of the phases, either the oil-phase or the aqueous-phase, is dispersed in the other. The emulsion may be an oil-in-water emulsion having an external aqueous-phase and a dispersed oil-phase. Alternatively, the emulsion may be a water-in-oil emulsion having an external oil-phase and a dispersed aqueous-phase.

The oil-phase may include one or more edible oils. The oil-phase may include one or more of a vegetable oil. The vegetable oil may be canola oil, coconut oil, corn oil, cottonseed oil, olive oil, palm oil, peanut oil, rapeseed oil, safflower oil, sesame oil, soybean oil or sunflower oil, or a combination thereof. In some embodiments, the oil is palm oil. The edible oil may also be an animal or marine oil. The edible oil may include saturated oils, unsaturated oils, or a mixture thereof.

The dispersed phase of the emulsion may be comprised of droplets of any of a wide range of sizes and droplet size distributions. Variations in size or distribution of droplets of the dispersed phase can influence taste, physical properties and speed of microbial deterioration. In some embodiments, the average particle size is 1 μm to 5 μm. For example, in some embodiments, 90% or more of the droplets are 1 μm to 5 μm, or 95% or more of the droplets are 1 μm to 5 μm. The dispersed phase need not take the form of classical droplets but may include other shapes, which may be measured via their largest dimension.

The oil and water emulsions of the present disclosure encompass a range of oil:water ratios from 100:1 oil-phase:aqueous-phase to 1:100 oil-phase:aqueous-phase. The wt % of the oil-phase can be about 30 wt % to about 90 wt % of the emulsion, about 70 wt % to about 90 wt %, or about 80 wt % to about 90 wt % of the emulsion. The wt % of the oil-phase can be less than 5 wt %, less than, equal to, or greater than, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt % or 94 wt %, or greater than 95 wt % of the emulsion. In some embodiments, the oil-phase is 80 wt % or more. Where wt % of the oil-phase is defined, the aqueous-phase may provide the balance or remainder wt % of the emulsion. The emulsion may be about 80 wt % oil-phase and about 20 wt % aqueous-phase; about 85 wt % oil-phase and about 15 wt % aqueous phase; about 90 wt % oil-phase and about 10 wt % aqueous phase; about 30 wt % oil-phase and about 70 wt % aqueous phase; about 40 wt % aqueous-phase and about 60 wt % oil-phase; and about 50 wt % oil-phase and about 50 wt % aqueous phase. The wt % of the aqueous-phase can be less than 1 wt %, less than, equal to, or greater than, about 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 30 wt %, 35 wt %, 40 wt %, 45 wt %, 50 wt %, 55 wt %, 60 wt %, 65 wt %, 70 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt % or 94 wt %, or greater than 95 wt % of the emulsion. The emulsion may be understood by wt % of the dispersed phase, the external phase, or both. As a non-limiting example, the dispersed phase may be about 10 wt % to about 20 wt % of the emulsion; the external phase may be about 80 wt % to about 90 wt % of the emulsion. As another example, the emulsion can have an oil-phase which is 80 wt % to 87% of the emulsion.

The emulsions of the present disclosure may have from about 1% fat content to about 99% fat content. The emulsion may have a fat content of at least about 5 wt %, less than, equal to, or greater than, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, or 90 wt %, or 95 wt % or greater of the emulsion. In some embodiments, the emulsion is a margarine and the fat content is at least 80 wt %. The emulsion may have a solid fat index (SFI) of about 2.5, about 7, about 13, or about 16 at 21.1° C. The SFI may be about 1 to about 4, about 4 to about 10, about 10 to about 15, about 15 to about 21, or about 21 or higher.

In some embodiments, oil and water are the major components of the emulsion. The emulsion may contain an amount of protein content or, alternatively, may be substantially free of protein content. The emulsion may contain an amount of carbohydrate content or, alternatively, may be substantially free of carbohydrate content. The emulsion may have a protein content of less than 1 wt % or less than, equal to, or greater than, 0.9 wt %, 0.8 wt %, 0.7 wt %, 0.6 wt %, 0.5 wt %, 0.4 wt %, 0.3 wt %, 0.2 wt %, 0.1 wt %, 0.01 wt %, 0.001 wt % or greater than 0.0001 wt % of the emulsion. The emulsion may have a carbohydrate content of less than 4 wt %, or less than, equal to, or greater than, 3.5 wt %, 3 wt %, 2.5 wt %, 2 wt %, 1.5 wt %, 1 wt %, 0.9 wt %, 0.8 wt %, 0.7 wt %, 0.6 wt %, 0.5 wt %, 0.4 wt %, 0.3 wt %, 0.2 wt %, 0.1 wt %, 0.01 wt %, 0.001 wt % or greater than 0.0001 wt % of the emulsion. The emulsion may include milk, butterfat, dairy isolates, or a combination thereof. The emulsion is dairy-free. The emulsion may include only an oil; an oil-soluble extract including carnosic acid, carnosol, or a mixture thereof; an emulsifier; a colorant; a flavor; water; a water-soluble spearmint extract; water soluble ascorbic acid, or salt thereof; citric acid; and sodium chloride; and the emulsion is free of other materials.

### Antioxidants.

The extract including carnosic acid, carnosol, or a mixture thereof can be an oil-soluble extract or a water-soluble extract. The carnosic acid, carnosol, or a mixture thereof, may be in the form of a salt or other water-soluble forms.

The extract including carnosic acid, carnosol, or a mixture thereof, can be present in the oil-phase or can have has greater affinity for the oil-phase than the aqueous-phase. For example, the extract including carnosic acid, carnosol, or a mixture thereof, can be present in the oil-phase at an amount corresponding to more than 50 wt %, 70 wt %, 80 wt %, 90 wt %, 95 wt % or 99 wt % of the total amount of said extract. The extract including carnosic acid, carnosol, or a mixture thereof, may reside at the interface of the oil-phase and aqueous-phase.

The extract including carnosic acid, carnosol, or a mixture thereof, can be a solution, an oil, a powder, a mixture of crystals, a suspension, or a combination thereof. The extract including carnosic acid, carnosol, or a mixture thereof, can be about 0.01 wt % active ingredients to about 100 wt % active ingredients. Active ingredients may be understood to mean ingredients which are antioxidants. The extract including carnosic acid, carnosol, or a mixture thereof, may contain active ingredients at about 5 wt % of the extract or from 4.2% to 5.5% active ingredients. The extract can be a solution, for example, an ethanol or acetone solution. In embodiments where the extract is an oil-soluble extract, the extract can contain oil-soluble components. The extract can be the product of an ethanol, acetone or super critical CO₂ extraction from plant material. The extract including carnosic acid, carnosol, or a mixture thereof, can be sage extract, such as an extract of Salvia officinalis. The extract including carnosic acid, carnosol, or a mixture thereof, may be a rosemary extract or a sage extract. As a non-limiting example, the rosemary extract is an extract of Rosmarinus officinalis. The extract including carnosic acid can be a water-soluble sage extract that is substantially free of oil-soluble sage extract, or an oil-soluble sage extract that is substantially free of water-soluble sage extract. The extract including carnosic acid can be a water-soluble rosemary extract that is substantially free of oil-soluble rosemary extract or an oil-soluble rosemary extract that is substantially free of water-soluble rosemary extract. The extract including carnosic acid, carnosol, or a mixture thereof, can be substantially free of other active ingredients. The extract including carnosic acid, carnosol or a mixture thereof can be purified carnosic acid, purified carnosol, or a mixture thereof.

The extract containing rosmarinic acid may be present in the aqueous-phase or may have greater affinity for the aqueous-phase than the oil-phase. The extract containing rosmarinic acid can be present in aqueous oil-phase at an amount corresponding to more than 50 wt %, 70 wt %, 80 wt %, 90 wt %, 95 wt % or 99 wt % of the total amount of said extract. The extract containing rosmarinic acid may reside at the interface of the oil-phase and aqueous-phase.

The extract containing rosmarinic acid may be a solution, an oil, a powder, a mixture of crystals, or a suspension. The spearmint extract may contain about 0.01 wt % active ingredients to about 100 wt % active ingredients. The extract containing rosmarinic acid may contain active ingredients at about 5 wt % of the extract or from 4.6% to 5.0% active ingredients. The extract containing rosmarinic acid may be a 5 wt % solution. The extract containing rosmarinic acid is an ethanol or acetone solution. In some embodiments, where the extract containing rosmarinic acid is an aqueous-soluble extract, the extract contains water-soluble components. The extract containing rosmarinic acid may be the product of hot-water or cold-water extraction from plant material. As a non-limiting example, the extract containing rosmarinic acid is a spearmint extract from Mentha spicata.

If the extract containing rosmarinic acid is a spearmint extract, it may include rosmarinic acid or includes rosmarinic acid as the predominant active ingredient. Such a spearmint extract may contain an amount of rosmarinic acid which accounts for more than 92% of total phenolic content of the spearmint extract as determined by a Folin-Ciocalteu assay. The spearmint extract may be substantially free of carnosic acid, carnosol, or a mixture thereof.

The extract including carnosic acid, carnosol, or a mixture thereof, can be about 0.005 wt % to about 0.10 wt % of the oil-phase, about 0.01 wt % to about 0.05 wt %, about 0.01 wt % to about 0.04 wt % of the oil-phase, or about 0.005 wt % or less, or less than, equal to, or greater than about 0.01 wt %, 0.02 wt %, 0.03 wt %, 0.04 wt %, 0.05 wt %, or 0.08 wt %, or about 0.1 wt % or more of the oil-phase.

The extract including carnosic acid, carnosol, or a mixture thereof, can be about 0.01 wt % to about 0.04 wt % of the emulsion, or about 0.01 wt % or less, or less than, equal to, or greater than about 0.01%, 0.02, 0.03, 0.04 wt %, or about 0.04 wt % or more of the emulsion.

Active ingredients of the extract including carnosic acid, carnosol, or a mixture thereof, are present in the emulsion at about 0.0005 wt % to about 0.002 wt % of the emulsion, or about 0.0005 wt % or less, or less than, equal to, or greater than about 0.0006 wt %, 0.007 wt %, 0.008 wt %, 0.009 wt %, 0.001 wt %, 0.0011 wt %, 0.0012 wt %, 0.0013 wt %, 0.0014 wt %, 0.0015 wt %, 0.0016 wt %, 0.0017 wt %, 0.0018 wt %, or 0.0019 wt %, or about 0.002 wt % or more of the emulsion.

The spearmint extract can be about 0.001 wt % to about 0.10 wt % of the aqueous phase, about 0.005 wt % to about 0.04 wt %, about 0.008 to about 0.03 wt %, or about 0.001 wt % or less, or less than, equal to, or greater than about 0.005 wt %, 0.010 wt %, 0.02 wt %, 0.03 wt %, 0.04 wt %, 0.05 wt %, 0.06 wt %, 0.07 wt %, 0.08 wt %, or 0.09 wt %, or about 0.10 wt % or more of the aqueous-phase. The spearmint extract may be about 0.00005 wt % to about 0.0001 wt % of the emulsion, or about 0.00005 wt % or less, or less than, equal to, or greater than about 0.00006 wt %, 0.00007 wt %, 0.00008 wt % or 0.00009 wt %, or about 0.0001 wt % or more of the emulsion. Active ingredients of the spearmint extract may be present in the emulsion at about 0.0000025 wt % to about 0.00005 wt % of the emulsion, about 25 ppb to about 500 ppb of the emulsion, or about 0.0000025 wt % or less, or less than, equal to, or greater than about 0.000003 wt %, 0.000004 wt %, 0.000005 wt %, 0.000006 wt %, 0.000007 wt %, 0.000008 wt %, 0.000009 wt %, 0.00001 wt %, 0.00002 wt %, 0.00003 wt %, or 0.00004 wt %, or about 0.00005 wt % or more of the emulsion.

The spearmint extract can be less than 0.0004 wt % or, further, less than 0.0001 wt % of the emulsion. Active ingredients of the spearmint extract may be less than 0.00005 wt % of the emulsion. It is unexpected that such a small amount of spearmint extract has an advantageous effect on the oxidative stability of some emulsions of the present invention. It is likewise unexpected that such a small amount of active ingredients from spearmint extract have such an advantageous effect on oxidative stability of some embodiments of the emulsion.

Other components.

The emulsifier can be about 0.005 wt % to about 1.0 wt %, about 0.1 wt % to about .5 wt %, 0.005 wt % or less, or less than, equal to, or greater than about 0.15 wt %, 0.20 wt %, 0.25 wt %, 0.30 wt %, 0.35 wt %, 0.40 wt % or 0.45 wt %, or greater than 1.0 wt % of the oil-phase. The emulsifier can be about 0.1 wt % to about 0.5 wt % of the emulsion, 0.1 wt % or less, or less than, equal to, or greater than 0.2 wt %, 0.3 wt %, or 0.4 wt %, or greater than 0.5 wt % of the emulsion. The emulsifier may reside at the interface of the oil-phase and aqueous-phase.

The emulsion of the present disclosure may further include ascorbic acid, an ascorbic acid derivative (e.g. ascorbic palmitate or other fatty acid esters of ascorbate), or a salt thereof (e.g., sodium L-ascorbate). The emulsion may include a (water-soluble) ascorbic acid, or a salt thereof.

The ascorbic acid, or a salt thereof, may be about 0.005 wt % to about 0.05 wt % of the aqueous-phase, or 0.005 wt % or less, or less than, equal to, or greater than about 0.007 wt %, 0.01 wt %, 0.02 wt %, 0.03 wt %, 0.04 wt %, or greater than 0.05 wt % of the aqueous-phase. The ascorbic acid, or a salt thereof, is about 0.0005 wt % to about 0.005 wt % of the emulsion, or 0.0005 wt % or less, or less than, equal to, or greater than 0.007 wt %, 0.01 wt %, 0.02 wt %, 0.03 wt %, 0.04 wt %, or greater than 0.05 wt % of the emulsion. The ascorbic acid, or a salt thereof, may be present in the aqueous-phase.

The emulsion of the present disclosure may further include at least one of citric acid, sodium chloride, colorant, flavoring or a combination thereof.

The citric acid can be about 0.005 wt % to about 0.05 wt % of the aqueous-phase, or 0.005 wt % or less, or less than, equal to, or greater than about 0.007 wt %, 0.01 wt %, 0.02 wt %, 0.03 wt %, 0.04 wt %, or greater than 0.05 wt % of the aqueous-phase. The citric acid can be about 0.0005 wt % to about 0.005 wt % of the emulsion, or 0.0005 wt % or less, or less than, equal to, or greater than about 0.007 wt %, 0.01 wt %, 0.02 wt %, 0.03 wt %, 0.04 wt %, or greater than 0.05 wt % of the emulsion. The citric acid may be in the aqueous-phase.

The sodium chloride can be about 0.1 wt % to about 1 wt % of the aqueous-phase, 0.1 wt % or less, or less than, equal to, or greater than about 0.2 wt %, 0.3 wt %, 0.4 wt %, 0.5 wt %, 0.6 wt %, 0.7 wt %, 0.8 wt % or 0.9 wt %, or greater than 1 wt % of the aqueous-phase. The sodium chloride can be about 0.01 wt % to about 0.2 wt % of the emulsion, or about 0.01 wt % or less, or less than, equal to, or greater than about 0.2 wt %, 0.3 wt %, 0.4 wt %, 0.5 wt %, 0.6 wt %, 0.7 wt %, 0.8 wt % or 0.9 wt %, or greater than 1 wt % of the emulsion. The sodium chloride may be in the aqueous-phase.

Colorant can be about 0.001 wt % to about 0.01 wt % of the oil-phase or about 0.001 wt % to about 0.01 wt % of the emulsion. The colorant may be in the aqueous-phase or in the oil-phase. The colorant may be carotene.

Flavoring can be about 0.05 wt % to about 0.5 wt % of the oil-phase or about 0.05 wt % to about 0.5 wt % of the emulsion. The flavoring may be in the oil-phase. The flavoring may have a buttery flavor. The flavoring may include diacetyl.

The emulsion of the present disclosure may further include water-soluble tea polyphenols.

The emulsifier may contain one or more of lecithins, mono- and diglycerides of fatty acids, esters of mono- and diglycerides of fatty acids, sucrose esters of fatty acids, sucroglycerides, polyglycol esters of fatty acids, polysorbitan esters and sorbitan esters. The emulsifier may be soy lecithin, at least one of mono- and diglycerides of fatty acids, or a mixture thereof. The emulsion may include an emulsifier having an amount of soy lecithin which is about 0.05 wt % to about 0.5 wt % of the oil-phase, or 0.05 wt % or less, or less than, equal to, or greater than about 0.07 wt %, 0.1 wt %, 0.2 wt %, 0.3 wt %, 0.4 wt %, or greater than 0.5 wt % of the oil-phase.

The emulsifier may have an amount of mono- and di-glycerides of fatty acids which are about 0.1 wt % to about 1.0 wt % of the oil-phase, about 0.1 wt % or less, or less than, equal to, or greater than about 0.2 wt %, 0.3 wt %, 0.4 wt %, 0.5 wt %, 0.6 wt %, 0.7 wt %, 0.8 wt % or 0.9 wt %, or greater than 1 wt % of the oil-phase.

The emulsifier may have a mixture of soy lecithin and mono- and di-glycerides of fatty acids which are, together, about 0.1 wt % to about 1.0 wt % of the oil-phase, about 0.1 wt % or less, or less than, equal to, or greater than about 0.2 wt %, 0.3 wt %, 0.4 wt %, 0.5 wt %, 0.6 wt %, 0.7 wt %, 0.8 wt % or 0.9 wt %, or greater than 1 wt % of the oil-phase. The emulsifier may be about 0.01 wt % to about 1 wt % of the emulsion, 0.1 wt % or less, or less than, equal to, or greater than about 0.2 wt %, 0.3 wt %, 0.4 wt %, 0.5 wt %, 0.6 wt %, 0.7 wt %, 0.8 wt % or 0.9 wt %, or greater than 1 wt % of the emulsion.

### Oxidative Stability.

Various embodiments of the emulsion are stable to oxidation as defined by a peroxide value (PV) less than or equal to 5 mmol/kg or, more advantageously, less than or equal to 2.5 mmol/kg, or about 0.1 mmol/kg to about 2.5 mmol/kg, or less than, equal to or greater than 0.5 mmol/kg, 1.0 mmol/kg, 1.5 mmol/kg, 2.0 mmol/kg, 2.5 mmol/kg, 3.0 mmol/kg, 3.5 mmol/kg, 4.0 mmol/kg or 4.5 mmol/kg, after 12 months storage. Some embodiments of the emulsion are stable to oxidation as defined by a peroxide value (PV) less than or equal to 5 mmol/kg or less than or equal to 2.5 mmol/kg, or about 0.1 mmol/kg to about 2.5 mmol/kg, or less than, equal to or greater than 0.5 mmol/kg, 1.0 mmol/kg, 1.5 mmol/kg, 2.0 mmol/kg, 2.5 mmol/kg, 3.0 mmol/kg, 3.5 mmol/kg, 4.0 mmol/kg or 4.5 mmol/kg, after 14 weeks, or after 0 to 14 weeks, or after, at, or before, 2 weeks, 4, weeks, 6 weeks, 8 weeks, 10 weeks or 12 weeks, of storage of a 50 g sample of emulsion in an open container in a 35° C. incubator. Such peroxide values are indicative of excellent shelf life with low degradation occurring after even 12 months of storage. Peroxide value (PV) provides a snapshot of the current oxidation activity occurring in the emulsion.

Some embodiments of the emulsion are stable as defined by GB15196-2015, the Chinese National Food Safety Standard—Edible Oils and Fats Products, which is hereby incorporated by reference. GB15196-2015 indicates a suitable peroxide value in fat (g/100 g) of less than or equal to 0.10 for edible hydrogenated oil and less than or equal to 0.13 for other products which may be tested by way of Method GB5009.227-2016, which is also incorporated herewith by reference.

Various embodiments of the present invention, advantageously, have improved stability to oxidation as defined by the peroxide value (PV) in comparison, for example, to emulsions which lack the combination of both a spearmint extract and an extract including carnosic acid, carnosol, or a mixture thereof.

In some embodiments, the emulsion is stable to oxidation as quantified by an anisidine value (AV) less than or equal to 100, less than or equal to 50, or less than or equal to 10, or at about 1 to about 100, or less than, equal to, or greater than, 1, 5, 10, 15, 20, 25, 30, 35, 40, 45, 50, 55, 60, 65, 70, 75, 80, 85, 90 or 95, or greater than 100, after 14 weeks, or after 0 to 14 weeks, or after, at, or before, 2 weeks, 4, weeks, 6 weeks, 8 weeks, 10 weeks or 12 weeks, of storage of a 50 g sample of emulsion in an open container in a 35° C. incubator. The emulsion can be stable to oxidation as quantified by an anisidine value (AV) less than or equal to 100, less than or equal to 50, or less than or equal to 10, or at about 1 to about 100, or less than, equal to, or greater than, 1, 5, 10, 15, 20, 25, 30, 35, 40, 45, 50, 55, 60, 65, 70, 75, 80, 85, 90 or 95, or greater than 100, after 12 months storage.

Various embodiments of the present invention, advantageously, have improved stability to oxidation as defined by a anisidine value (AV) in comparison, for example, to emulsions which lack the combination of both a spearmint extract and an extract including carnosic acid, carnosol, or a mixture thereof.

In certain embodiments of the emulsion, any antioxidants in the emulsion are plant-derived antioxidants. In some embodiments, any antioxidants in the emulsion are carnosic acid, carnosol, spearmint extract and components thereof, sage extract and components thereof, rosemary extract and components thereof, ascorbic acid or salts thereof, carotene or citric acid. The emulsion may, in some embodiments, consist of an oil; an oil-soluble extract comprising carnosic acid, carnosol, or a mixture thereof; an emulsifier; a colorant; a flavor; water; a water-soluble spearmint extract; water soluble ascorbic acid, or salt thereof; citric acid; and sodium chloride. The emulsion may have the advantage of a limited list of ingredients, such that no more than 12, 11, 10, 9 8, 7, 6, 5 or 4 ingredients need be listed on product labels.

### Methods of Forming an Emulsion.

The present disclosure also provides methods of preparing an emulsion, such as any emulsion described herein.

In some embodiments, the method includes: dissolving an emulsifier and an oil-soluble extract including carnosic acid, carnosol, or a mixture thereof, in an oil and heating the oil to 70° C. to form an oil-phase; dissolving a water-soluble spearmint extract, citric acid and ascorbic acid, or salt thereof, in water and heating the water to 70° C. to form an aqueous-phase; and emulsifying the oil-phase and the aqueous-phase together to obtain the emulsion.

The method of preparing the emulsion of the present disclosure may include combining and emulsifying separately pre-mixed oil-phase and aqueous-phase, wherein the pre-mixed oil-phase includes the extract including carnosic acid, carnosol, or a mixture thereof; and the pre-mixed aqueous-phase includes water and the spearmint extract.

The method may include combining and emulsifying separately pre-mixed oil-phase and aqueous-phase, wherein the pre-mixed oil-phase includes the oil and oil-soluble components; and the pre-mixed aqueous-phase includes water and water-soluble components.

The pre-mixed oil-phase may include the emulsifier; or the pre-mixed aqueous phase may include ascorbic acid, or a salt thereof; or both. The pre-mixed oil-phase may contain colorant and flavor and the pre-mixed aqueous-phase may contain citric acid and sodium chloride.

The emulsifier may be mixed with the water prior to contacting the oil-phase or the emulsifier may be mixed with the oil prior to contacting the aqueous-phase.

The method may further include heating one or both of the pre-mixed oil-phase and the pre-mixed aqueous phase to a temperature of 50° C. to 90° C. or to about 70° C. prior to combining the aqueous-phase and the oil-phase.

### EXAMPLES

Various embodiments of the present disclosure can be better understood by reference to the following Examples which are offered by way of illustration. The present disclosure is not limited to the Examples given herein.

TABLE 1
Ingredients

| Ingredient | Source |
|---|---|
| Palm Oil | Cargill, Incorporated, Wayzata, Minnesota, |
| | USA |
| Mono- and diglycerides of fatty acids | Danisco, Copenhagen, Denmark |
| Carotene, 30 wt % solution | Kemin Industries, Inc., Des Moines, Iowa, |
| | USA |
| Flavor | Givaudan, Vernier, Switzerland |
| Rosemary extract (oil-soluble), 5 wt % | Naturex SA, Avignon, France |
| active ingredients in solution | |
| Soy lecithin | Cargill, Incorporated, Wayzata, Minnesota, |
| | USA |
| Vitamin C | DSM, Heerlen, Netherlands |
| Ascorbyl palmitate | DSM, Heerlen, Netherlands |
| Sage extract (oil-soluble), 5 wt % active | Naturex SA, Avignon, France |
| ingredients in solution | |
| Tea polyphenol palmitates | Kemin Industries, Inc., Des Moines, Iowa, |
| | USA |
| Tea polyphenols (water-soluble), 5 wt % | Naturex SA, Avignon, France |
| active ingredients in solution | |
| Spearmint extract (water-soluble), 5 wt % | Kemin Industries, Inc., Des Moines, Iowa, |
| active ingredients in solution | USA |

### Peroxide Value (PV).

Peroxide Value (PV) may be determined using ISO3960/1994, which is incorporated herewith by reference, or by other art recognized means. The peroxide value corresponds to the quantity of those substances in the sample, expressed in terms of active oxygen, that oxidize potassium iodide. The peroxide value may be expressed in milliequivalents (meq) of active oxygen per kilogram of oil, but it may also be expressed (in SI units) as millimoles (mmol) of active oxygen per kilogram of oil. The value expressed in millimoles of active oxygen per kilogram is half that expressed in milliequivalents of active oxygen per kilogram. Peroxide Value (PV) may also be determined using China Regulation GB5009.227-2016, which is hereby incorporated by reference. The PV values determined in connection with Examples 1-9 were measured according to the method of China Regulation GB5009.227-2016.

### Anisidine Value (AV).

p-Anisidine value (AV) may be determined using International Organization for Standardization method ISO6885/1994, which is incorporated herewith by reference, or by other art recognized means. The anisidine value corresponds to one hundred times the increase in absorbance, measured at a wavelength of 350 nm in a 10 mm cell, of a test solution when reacted with p-anisidine under the test conditions. The anisidine value has no dimensions, and is calculated and quoted on the basis of 1 g of the test sample in 100 ml of a mixture of solvent and reagent.

### Emulsification Process.

Emulsification may be performed via a continuous emulsification process. In the continuous process, the oil-phase may be metered into a line feed tank or mixed in-line using metering pumps or mass flow meters. The emulsification may be performed by use of a multihead pump which meters out the desired components. In-line static mixers may be used to combine separate phases, which may then be joined in-line and emulsified by a further static mixer. Emulsification may also be performed via a batch process. In the batch process, the oil-phase may be prepared in an agitated tank or “churn” to which the aqueous phase is added, and the phases further mixed. Emulsion may be subsequently followed by cooling, working, resting, and packaging steps.

### General Method.

A pre-mixed oil-phase was prepared by combining 0.3 wt % mono- and diglycerides of fatty acids, 0.1 wt % soy lecithin, 0.0035 wt % carotene and 0.1 wt % flavor in palm oil and heating the oil mixture to 70° C., with each weight percent corresponding to the total weight of the oil-phase. A pre-mixed aqueous phase was prepared by combining 0.02 wt % citric acid and 0.5 wt % sodium chloride and heating the water mixture to 70° C., with each weight percent corresponding to the total weight of the aqueous-phase. Per each example below, one or more antioxidant was additionally included in the oil-phase, the aqueous-phase, or both. The pre-mixed oil-phase and pre-mixed water phase were combined at 70° C. at a proportion of 84.5:15.5 oil-phase: aqueous-phase and mixed for 30 minutes cooled and homogenized though a high pressure mixer under standard conditions. The resulting emulsion having 84.5 wt % oil-phase and 15.5 wt % aqueous-phase showed initial PV levels of 0.37 mmol/Kg. Table 2 summarizes the combination of ingredients used in each Example. Table 3 shows the effect of different antioxidants in either the oil-phase or the aqueous-phase on PV levels after 14 weeks of accelerated shelf life testing.

TABLE 2
Summary of Examples 1-9.

| | | | | | | | | | |
|---|---|---|---|---|---|---|---|---|---|
| Ex. 1 | Ex. 2 | Ex. 3 | Ex. 4 | Ex. 5 | Ex. 6 | Ex. 7 | Ex. 8 | Ex. 9a | Ex. 9b |

Oil-phase (84.5 wt % total. Components % values below correspond to wt % of oil-phase)

| | | | | | | | | | | |
|---|---|---|---|---|---|---|---|---|---|---|
| Mono- and | 0.3% | 0.3% | 0.3% | 0.3% | 0.3% | 0.3% | 0.3% | 0.3% | 0.3% | 0.3% |
| diglycerides | | | | | | | | | | |
| of fatty | | | | | | | | | | |
| acids | | | | | | | | | | |
| Soy | 0.1% | 0.1% | 0.1% | 0.1% | 0.1% | 0.1% | 0.1% | 0.1% | 0.1% | 0.1% |
| lecithin | | | | | | | | | | |
| Carotene | .0035% | .0035% | .0035% | .0035% | .0035% | .0035% | .0035% | .0035% | .0035% | .0035% |
| Flavor | 0.1% | 0.1% | 0.1% | 0.1% | 0.1% | 0.1% | 0.1% | 0.1% | 0.1% | 0.1% |
| BHA | 0.006% | | | | | | | | | |
| BHT | 0.006% | | | | | | | | | |
| Vitamin E | | 0.02% | 0.01% | | | | | | | |
| Ascorbyl | | | 0.01% | 0.01% | | | | | | |
| palmitate | | | | | | | | | | |
| Rosemary | | | | 0.03% | 0.03% | | | | | 0.03% |
| extract | | | | | | | | | | |
| Oil- | | | | | | 0.03% | | | | |
| soluble tea | | | | | | | | | | |
| poly- | | | | | | | | | | |
| phenol | | | | | | | | | | |
| palmitates | | | | | | | | | | |
| Oil- | | | | | | | 0.03% | 0.03% | 0.03% | |
| soluble | | | | | | | | | | |
| sage | | | | | | | | | | |
| extract | | | | | | | | | | |
| Palm oil | >99% | >99% | >99% | >99% | >99% | >99% | >99% | >99% | >99% | >99% |

Aqueous-phase (15.5 wt % of total. Component % values below correspond to wt % of aqueous-phase)

| | | | | | | | | | | |
|---|---|---|---|---|---|---|---|---|---|---|
| Citric acid | 0.02% | 0.02% | 0.02% | 0.02% | 0.02% | 0.02% | 0.02% | 0.02% | 0.02% | 0.02% |
| Sodium | 0.5% | 0.5% | 0.5% | 0.5% | 0.5% | 0.5% | 0.5% | 0.5% | 0.5% | 0.5% |
| chloride | | | | | | | | | | |
| Water- | | | | | | 0.01% | | | | |
| soluble tea | | | | | | | | | | |
| poly- | | | | | | | | | | |
| phenols | | | | | | | | | | |
| Vitamin C | | | | | | 0.01% | 0.01% | | 0.01% | 0.01% |
| Spearmint | | | | | | | | | 0.03% | 0.03% |
| extract | | | | | | | | | | |
| Water | >99% | >99% | >99% | >99% | >99% | >99% | >99% | >99% | >99% | >99% |

TABLE 3
Comparison of PV Values During Accelerated Testing

| | Additional oil-phase | Additional aqueous-phase | | |
|---|---|---|---|---|
| | component | component | | |
| | (% is wt % based on total oil- | (% value is wt % based on total | Initial PV | PV mmol/kg |
| | phase) | aqueous-phase) | mmol/Kg | at 14 weeks |
| Ex. 1 | 0.006% BHA; and | | 0.37 | 11 |
| | 0.006% BHT | | | |
| Ex. 2 | 0.02% Vitamin E | | 0.37 | 9.9 |
| Ex. 3 | 0.02% Vitamin E; and | | 0.37 | 7.3 |
| | 0.01% ascorbyl palmitate | | | |
| Ex. 4 | 0.03% Oil-soluble rosemary | | 0.37 | 5.7 |
| | extract; and | | | |
| | 0.01% ascorbyl palmitate | | | |
| Ex. 5 | 0.03% Oil-soluble rosemary | | 0.37 | 8.6 |
| | extract | | | |
| Ex. 6 | 0.03% Oil-soluble tea | 0.01% water-soluble tea | 0.37 | 6.0 |
| | polyphenol palmitates | polyphenols | | |
| Ex. 7 | 0.03% Oil-soluble sage extract | 0.01% water-soluble | 0.37 | 6.7 |
| | | vitamin C | | |
| Ex. 8 | 0.03% Oil-soluble sage extract | | 0.37 | 8.6 |
| Ex. 9a | 0.03% Oil-soluble sage extract | 0.03% water-soluble spearmint | 0.37 | 2.4 |
| | | extract; and | | |
| | | 0.01% water-soluble vitamin C | | |
| Ex. 9b | 0.03% Oil-soluble rosemary | 0.03% water-soluble spearmint | 0.37 | 2.4 |
| | extract | extract and | | |
| | | 0.01% water-soluble vitamin C | | |

### Example 1

### 0.006 wt % BHA and 0.006 wt % BHT in Pre-Mixed Oil-Phase

The emulsion of Example 1 was prepared according to the General Method with the modification that 0.006 wt % BHA and 0.006 wt % BHT was added to the pre-mixed oil-phase, with wt % based on oil-phase. The resulting emulsion of Example 1 showed PV levels of 11 mmol/kg after 14 weeks of accelerated shelf life testing.

### Example 2

### 0.02 wt % Vitamin E in Pre-Mixed Oil-Phase

The emulsion of Example 2 was prepared according to the General Method with the modification that 0.02 wt % Vitamin E was added to the pre-mixed oil-phase, with wt % based on oil-phase. The resulting emulsion of Example 2 showed PV levels of 9.9 mmol/kg after 14 weeks of accelerated shelf life testing.

### Example 3

### 0.02 wt % Vitamin E and 0.01 wt % Ascorbyl Palmitate in Pre-Mixed Oil-Phase.

The emulsion of Example 3 was prepared according to the General Method with the modification that 0.02 wt % Vitamin E and 0.01 wt % ascorbyl palmitate were added to the pre-mixed oil-phase, with wt % based on oil-phase. The resulting emulsion of Example 3 showed PV levels of 7.3 mmol/kg after 14 weeks of accelerated shelf life testing.

### Example 4

### 0.03 wt % Oil-Soluble Rosemary Extract and 0.01 wt % Ascorbyl Palmitate in Pre-Mixed Oil-Phase

The emulsion of Example 4 was prepared according to the General Method with the modification that 0.03 wt % oil-soluble rosemary extract and 0.01 wt % ascorbyl palmitate were added to the pre-mixed oil-phase with wt % based on oil-phase. The resulting emulsion of Example 4 showed PV levels of 5.7 mmol/kg after 14 weeks of accelerated shelf life testing.

### Example 5

### 0.03 wt % Oil-Soluble Rosemary Extract in Pre-Mixed Oil-Phase

The emulsion of Example 5 was prepared according to the General Method with the modification that 0.03 wt % oil-soluble rosemary extract was added to the pre-mixed oil-phase with wt % based on oil-phase. The resulting emulsion of Example 5 showed PV levels of 8.6 mmol/kg after 14 weeks of accelerated shelf life testing.

### Example 6

### 0.03 wt % Oil-Soluble Tea Polyphenol Palmitates in Pre-Mixed Oil-Phase and 0.01 wt % Water-Soluble Tea Polyphenols in Pre-Mixed Aqueous-Phase

The emulsion of Example 6 was prepared according to the General Method with the modification that 0.03 wt % oil-soluble tea polyphenol palmitates were added to the pre-mixed oil-phase, with wt % based on oil-phase, and 0.01 wt % water-soluble tea polyphenols were added to the pre-mixed aqueous-phase, with wt % based on aqueous-phase. The resulting emulsion of Example 6 showed PV levels of 6.0 mmol/kg after 14 weeks of accelerated shelf life testing.

### Example 7

### 0.03 wt % Oil-Soluble Sage Extract in Pre-Mixed Oil-Phase and 0.01 wt % Vitamin C in Pre-Mixed Aqueous-Phase

The emulsion of Example 7 was prepared according to the General Method with the modification that 0.03 wt % Oil-soluble sage extract added to the pre-mixed oil-phase, with wt % based on oil-phase, and 0.01 wt % vitamin C was added to the pre-mixed aqueous-phase, with wt % based on aqueous-phase. The resulting emulsion of Example 7showed PV levels of 6.7 mmol/kg after 14 weeks of accelerated shelf life testing.

### Example 8

### 0.03 wt % Oil-Soluble Sage Extract in Pre-Mixed Oil-Phase

The emulsion of Example 8 was prepared according to the General Method with the modification that 0.03 wt % oil-soluble sage extract was added to the pre-mixed oil-phase, with wt % based on oil-phase. The resulting emulsion of Example 8showed PV levels of 8.6 mmol/kg after 14 weeks of accelerated shelf life testing.

### Example 9a

### 0.03 wt % Oil-Soluble Sage Extract in Pre-Mixed Oil-Phase and 0.01 wt % Vitamin C and 0.03 wt % Water-Soluble Spearmint Extract in Pre-Mixed Aqueous-Phase

The emulsion of Example 9a was prepared according to the General Method with the modification that 0.03 wt % oil-soluble sage extract was added to the pre-mixed oil-phase, with wt % based on oil-phase, and 0.03 wt % water-soluble spearmint extract and 0.01 wt % water-soluble vitamin C were added to the pre-mixed aqueous-phase, with wt % based on aqueous-phase. The resulting emulsion showed improved stability compared to Examples 1-8. The emulsion was sufficiently stable to meet the requirements of Chinese Regulation GB15196-2015. The showed PV levels less than or equal to 5 mmol/kg after 12 months of storage. The emulsion showed PV levels of 2.4 mmol/kg after 14 weeks of accelerated shelf life testing.

### Example 9b

### 0.03 wt % Oil-Soluble Rosemary Extract in Pre-Mixed Oil-Phase and 0.01 wt % Vitamin C and 0.03 wt % Water-Soluble Spearmint Extract in Pre-Mixed Aqueous-Phase

The emulsion of Example 9b was prepared according to the General Method with the modification that 0.03 wt % oil-soluble rosemary extract was added to the pre-mixed oil-phase, with wt % based on oil-phase, and 0.03 wt % water-soluble spearmint extract and 0.01 wt % water-soluble vitamin C were added to the pre-mixed aqueous-phase, with wt % based on aqueous-phase. The resulting emulsion showed improved stability compared to Examples 1-8. The emulsion was sufficiently stable to meet the requirements of Chinese Regulation GB15196-2015. The emulsion showed PV levels less than or equal to 5 mmol/kg after 12 months of storage. The emulsion showed PV levels of 2.4 mmol/kg after 14 weeks of accelerated shelf life testing.

### Example 10

### 0.01 wt % Vitamin C and 0.03 wt % Water-Soluble Spearmint Extract in Pre-Mixed Aqueous-Phase

The emulsion of Example 10 is prepared according to the General Method with the modification that 0.03 wt % water-soluble spearmint extract and 0.01 wt % water-soluble vitamin C is added to the pre-mixed aqueous-phase, with wt % based on aqueous-phase. Example 10 results in an emulsion which shows oxidation values that are not as low as the oxidation values shown by Examples 9a and 9b. Example 10 shows results indicating that the oxidative stability achieved by the emulsion of Examples 9a and 9b is the result of a more-than-additive effect.

### Example 11

### 0.03 wt % Water-Soluble Spearmint Extract in Pre-Mixed Aqueous-Phase

The emulsion of Example 11 is prepared according to the General Method with the modification that 0.03 wt % water-soluble spearmint extract is added to the pre-mixed aqueous-phase, with wt % based on aqueous-phase. Example 11 results in an emulsion which shows oxidation values that are not as low as the oxidation values shown by Examples 9a and 9b. Example 11 shows results indicating that the oxidative stability achieved by the emulsion of Examples 9a and 9b is the result of a more-than-additive effect.

### Example 12

### 0.03 wt % Oil-Soluble Tea Polyphenol Palmitates in Pre-Mixed Oil-Phase and 0.01 wt % Water-Soluble Tea Polyphenols and 0.03 wt % Spearmint Extract in Pre-Mixed Aqueous-Phase

The emulsion of Example 12 is prepared according to the General Method with the modification that 0.03 wt % oil-soluble tea polyphenol palmitates were added to the pre-mixed oil-phase, with wt % based on oil-phase, and 0.03 wt % water-soluble spearmint extract and 0.01 wt % water-soluble tea polyphenols were added to the pre-mixed aqueous-phase, with wt % based on aqueous-phase. Example 12 results in an emulsion which shows oxidation values that are not as low as the oxidation values shown by Examples 9a and 9b. Example 12 shows results suggesting that the oxidative stability achieved by the emulsion of Examples 9a and 9b is the result of a synergistic effect.

### Example 13

### 0.03 wt % Oil-Soluble Sage Extract in Pre-Mixed Oil-Phase and 0.01 wt % Vitamin C and 0.03 wt % Water-Soluble Spearmint extract in Pre-Mixed Aqueous-Pphase

The emulsion of Example 13 is prepared according to the method of Example 9a with the modification that instead of pre-mixing certain ingredients in the oil-phase and the aqueous-phase, all ingredients are added at the same step to a mixture of oil and water. Example 13 results in an emulsion which shows oxidation values that are not as low as the oxidation values shown by Examples 9a and 9b. Example 13 shows results suggesting that the oxidative stability achieved by the emulsion of Examples 9a and 9b is the result of unexpected advantages of performing the specific pre-mixing steps described herein.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

### Additional Embodiments

The following exemplary embodiments are provided, the numbering of which is not to be construed as designating levels of importance:

Embodiment 1. provides an emulsion comprising:
an oil-phase;
an aqueous-phase;
an extract comprising carnosic acid, carnosol, or a mixture thereof;
a spearmint extract; and
an emulsifier.

Embodiment 2. provides the emulsion of Embodiment 1, wherein the spearmint extract is a water-soluble extract.

Embodiment 3. provides the emulsion of Embodiment 1 or Embodiment 2, wherein the extract comprising carnosic acid, carnosol, or a mixture thereof, is an oil-soluble extract.

Embodiment 4. provides the emulsion of any one of Embodiments 1-3, wherein the extract comprising carnosic acid, carnosol, or a mixture thereof, is present in the oil-phase.

Embodiment 5. provides the emulsion of any one of Embodiments 1-4, wherein the extract comprising carnosic acid, carnosol, or a mixture thereof, has greater affinity for the oil-phase than the aqueous-phase.

Embodiment 6. provides the emulsion of any one of Embodiments 1-5, wherein the spearmint extract is present in the aqueous-phase.

Embodiment 7. provides the emulsion of any one of Embodiments 1-6, wherein the spearmint extract has greater affinity for the aqueous-phase than the oil-phase.

Embodiment 8. provides the emulsion of any one of Embodiments 1-7, wherein the extract comprising carnosic acid, carnosol, or a mixture thereof, is sage extract or rosemary extract.

Embodiment 9. provides the emulsion of Embodiment 8, wherein the sage extract is an extract of Salvia officinalis.

Embodiment 10. provides the emulsion of Embodiment 8, wherein the rosemary extract is an extract of Rosmarinus officinalis.

Embodiment 11. provides the emulsion of any one of Embodiments 1-10, wherein the extract comprising carnosic acid, carnosol, or a mixture thereof is a 5 wt % solution of active ingredients.

Embodiment 12. provides the emulsion of any one of Embodiments 1-11, wherein the spearmint extract is an extract of Mentha spicata.

Embodiment 13. provides the emulsion of any one of Embodiments 1-12, wherein the spearmint extract comprises rosmarinic acid.

Embodiment 14. provides the emulsion of any one of Embodiments 1-13, wherein the extract comprising carnosic acid, carnosol, or a mixture thereof, is at about 0.005 wt % to about 0.10 wt % of the oil-phase.

Embodiment 15. provides the emulsion of any one of Embodiments 1-14, wherein the extract comprising carnosic acid, carnosol, or a mixture thereof, at about 0.01 wt % to about 0.04 wt % of the oil-phase.

Embodiment 16. provides the emulsion of any one of Embodiments 1-15, wherein the extract comprising carnosic acid, carnosol, or a mixture thereof, is about 0.01 wt % to about 0.04 wt % of the emulsion.

Embodiment 17. provides the emulsion of any one of Embodiments 1-16, wherein active ingredients of the extract comprising carnosic acid, carnosol, or a mixture thereof, are present in the emulsion at about 0.0005 wt % to about 0.002 wt % of the emulsion.

Embodiment 18. provides the emulsion of any one of Embodiments 1-17, wherein the spearmint extract is about 0.001 wt % to about 0.10 wt % of the aqueous-phase.

Embodiment 19. provides the emulsion of any one of Embodiments 1-18, wherein the spearmint extract is about 0.005 wt % to about 0.04 wt % of the aqueous-phase.

Embodiment 20. provides the emulsion of any one of Embodiments 1-19, wherein the spearmint extract is about 0.00005 wt % to about 0.0001 wt % of the emulsion.

Embodiment 21. provides the emulsion of any one of Embodiments 1-20, wherein active ingredients of the spearmint extract are present in the emulsion at about 0.0000025 wt % to about 0.00005 wt % of the emulsion.

Embodiment 22. provides the emulsion of any one of Embodiments 1-21, wherein the emulsifier is about 0.005 wt % to about 1.0 wt % of the oil-phase.

Embodiment 23. provides the emulsion of any one of Embodiments 1-22, wherein the emulsifier is about 0.1 wt % to about 0.5 wt % of the oil-phase.

Embodiment 24. provides the emulsion of any one of Embodiments 1-23, wherein the emulsifier is about 0.1 wt % to about 0.5 wt % of the emulsion.

Embodiment 25. provides the emulsion of any one of Embodiments 1-24, comprising ascorbic acid, an ascorbic acid derivative or a salt thereof.

Embodiment 26. provides the emulsion of any one of Embodiments 1-24, comprising ascorbic acid, or a salt thereof.

Embodiment 27. provides the emulsion of Embodiment 26, or salt thereof, is sodium L-ascorbate.

Embodiment 28. provides the emulsion of any one of Embodiments 1-27, wherein the ascorbic acid, or a salt thereof, is about 0.005 wt % to about 0.05 wt % of the aqueous-phase.

Embodiment 29. provides the emulsion of any one of Embodiments 1-28, wherein the ascorbic acid, or a salt thereof, is about 0.0005 wt % to about 0.005 wt % of the emulsion.

Embodiment 30. provides the emulsion of any one of Embodiments 1-29, wherein the ascorbic acid, or a salt thereof, is present in the aqueous-phase.

Embodiment 31. provides the emulsion of any one of Embodiments 1-30, further comprising at least one of citric acid, sodium chloride, colorant, flavoring or a combination thereof.

Embodiment 32. provides the emulsion of any one of Embodiments 1-31, further comprising citric acid.

Embodiment 33. provides the emulsion of any one of Embodiments 1-32, wherein the citric acid is about 0.005 wt % to about 0.05 wt % of the aqueous-phase.

Embodiment 34. provides the emulsion of any one of Embodiments 1-33, wherein the citric acid is about 0.0005 wt % to about 0.005 wt % of the emulsion.

Embodiment 35. provides the emulsion of any one of Embodiments 1-34, wherein the citric acid is in the aqueous-phase.

Embodiment 36. provides the emulsion of any one of Embodiments 1-35, further comprising sodium chloride.

Embodiment 37. provides the emulsion of any one of Embodiments 1-36, wherein the sodium chloride is about 0.1 wt % to about 1 wt % of the aqueous-phase.

Embodiment 38. provides the emulsion of any one of Embodiments 1-37, wherein the sodium chloride is about 0.01 wt % to about 0.2 wt % of the emulsion.

Embodiment 39. provides the emulsion of any one of Embodiments 1-38, wherein the sodium chloride is in the aqueous-phase.

Embodiment 40. provides the emulsion of any one of Embodiments 1-39, further comprising a colorant.

Embodiment 41. provides the emulsion of any one of Embodiments 1-40, wherein the colorant is about 0.001 wt % to about 0.01 wt % of the oil-phase.

Embodiment 42. provides the emulsion of any one of Embodiments 1-41, wherein the colorant is about 0.001 wt % to about 0.01 wt % of the emulsion.

Embodiment 43. provides the emulsion of any one of Embodiments 1-42, wherein the colorant is in the aqueous-phase.

Embodiment 44. provides the emulsion of any one of Embodiments 1-43, wherein the colorant is in the oil-phase.

Embodiment 45. provides the emulsion of any one of Embodiments 1-44, wherein the colorant is carotene.

Embodiment 46. provides the emulsion of any one of Embodiments 1-45, further comprising flavoring.

Embodiment 47. provides the emulsion of any one of Embodiments 1-46, wherein the flavoring is about 0.05 wt % to about 0.5 wt % of the oil-phase.

Embodiment 48. provides the emulsion of any one of Embodiments 1-47, wherein the flavoring is about 0.05 wt % to about 0.5 wt % of the emulsion.

Embodiment 49. provides the emulsion of any one of Embodiments 1-48, wherein the flavoring is present in the oil-phase.

Embodiment 50. provides the emulsion of any one of Embodiments 1-49, further comprising water-soluble tea polyphenols.

Embodiment 51. provides the emulsion of any one of Embodiments 1-50, wherein the oil-phase comprises one or more edible oils.

Embodiment 52. provides the emulsion of any one of Embodiments 1-51, wherein the oil-phase comprises one or more of a vegetable oil.

Embodiment 53. provides the emulsion of Embodiment 52, wherein the vegetable oil is canola oil, coconut oil, corn oil, cottonseed oil, olive oil, palm oil, peanut oil, rapeseed oil, safflower oil, sesame oil, soybean oil or sunflower oil, or a combination thereof.

Embodiment 54. provides the emulsion of any one of Embodiments 1-53, wherein the oil-phase comprises palm oil.

Embodiment 55. provides the emulsion of any one of Embodiments 1-54, wherein the emulsifier comprises one or more of lecithins, mono- and diglycerides of fatty acids, esters of mono- and diglycerides of fatty acids, sucrose esters of fatty acids, sucroglycerides, polyglycol esters of fatty acids, polysorbitan esters and sorbitan esters.

Embodiment 56. provides the emulsion of any one of Embodiments 1-55, wherein the emulsifier comprises soy lecithin.

Embodiment 57. provides the emulsion of any one of Embodiments 1-56, wherein the emulsifier comprises at least one of mono- and di-glycerides of fatty acids.

Embodiment 58. provides the emulsion of any one of Embodiments 1-57, wherein the emulsifier is a mixture of soy lecithin and mono- and di-glycerides of fatty acids.

Embodiment 59. provides the emulsion of any one of Embodiments 1-58, wherein the emulsifier comprises soy lecithin which is about 0.05 wt % to about 0.5 wt % of the oil-phase.

Embodiment 60. provides the emulsion of any one of Embodiments 1-59, wherein the emulsifier is about 0.01 wt % to about 1 wt % of the oil-phase.

Embodiment 61. provides the emulsion of any one of Embodiments 1-60, wherein the emulsifier comprises mono- and di-glycerides of fatty acids which are about 0.1 wt % to about 1.0 wt % of the oil-phase.

Embodiment 62. provides the emulsion of any one of Embodiments 1-61, wherein the emulsifier is about 0.01 wt % to about 1.0 wt % of the emulsion.

Embodiment 63. provides the emulsion of any one of Embodiments 1-62, wherein the emulsion is an oil-in-water emulsion having an external aqueous-phase and a dispersed oil-phase.

Embodiment 64. provides the emulsion of any one of Embodiments 1-63, wherein the emulsion is a water-in-oil emulsion having an external oil-phase and a dispersed aqueous-phase.

Embodiment 65. provides the emulsion of any one of Embodiments 1-64, wherein the dispersed phase comprises droplets having an average size of about 1 μm to 5 μm.

Embodiment 66. provides the emulsion of any one of Embodiments 1-65, wherein the dispersed phase comprises droplets having a size distribution where 90% of the droplets are about 1 μm to about 5 μm.

Embodiment 67. provides the emulsion of any one of Embodiments 1-66, wherein the oil-phase is about 30 wt % to about 90 wt % of the emulsion.

Embodiment 68. provides the emulsion of any one of Embodiments 1-66, wherein the oil-phase is about 70 wt % to about 90 wt % of the emulsion.

Embodiment 69. provides the emulsion of any one of Embodiments 1-66, wherein the oil-phase is about 80 wt % to about 90 wt % of the emulsion.

Embodiment 70. provides the emulsion of any one of Embodiments 1-69, wherein the aqueous-phase is about 10 wt % to about 70 wt % of the emulsion.

Embodiment 71. provides the emulsion of any one of Embodiments 1-69, wherein the aqueous-phase is about 10 wt % to about 30 wt % of the emulsion.

Embodiment 72. provides the emulsion of any one of Embodiments 1-69, wherein the aqueous-phase is about 10 wt % to about 20 wt % of the emulsion.

Embodiment 73. provides the emulsion of any one of Embodiments 1-66, wherein the dispersed phase is about 10 wt % to about 70 wt % of the emulsion.

Embodiment 74. provides the emulsion of any one of Embodiments 1-66, wherein the external phase is about 80 wt % to about 90 wt % of the emulsion.

Embodiment 75. provides the emulsion of any one of Embodiments 1-74, wherein the emulsion is spreadable at room temperature.

Embodiment 76. provides the emulsion of any one of Embodiments 1-75, wherein the emulsion is solid at room temperature.

Embodiment 77. provides the emulsion of any one of Embodiments 1-75, wherein the emulsion is semi-solid at room temperature.

Embodiment 78. provides the emulsion of any one of Embodiments 1-75, wherein the emulsion is liquid at room temperature.

Embodiment 79. provides the emulsion of any one of Embodiments 1-78, wherein the emulsion is stable to oxidation as defined by a peroxide value (PV) less than or equal to 5 mmol/kg after 12 months storage.

Embodiment 80. provides the emulsion of any one of Embodiments 1-79, wherein the emulsion is stable to oxidation as defined by a peroxide value (PV) less than or equal to 2.5 mmol/kg after 12 months storage.

Embodiment 81. provides the emulsion of any one of Embodiments 1-80, wherein the emulsion is stable to oxidation as defined by a peroxide value (PV) less than or equal to 5 mmol/kg after 14 weeks of storage of a 50 g sample of emulsion in an open container in a 35° C. incubator.

Embodiment 82. provides the emulsion of any one of Embodiments 1-81, wherein the emulsion is stable to oxidation as defined by a peroxide value (PV) less than or equal to 2.5 mmol/kg after 14 weeks of storage of a 50 g sample of emulsion in an open container in a 35° C. incubator.

Embodiment 83. provides the emulsion of any one of Embodiments 1-82, wherein the emulsion is stable as defined by GB15196-2015.

Embodiment 84. provides the emulsion of any one of Embodiments 1-83, wherein the emulsion is stable to oxidation as quantified by an anisidine value (AV) less than or equal to 100 after 14 weeks of storage of a 50 g sample of emulsion in an open container in a 35° C. incubator.

Embodiment 85. provides the emulsion of any one of Embodiments 1-84, wherein the emulsion is stable to oxidation as quantified by an anisidine value (AV) less than or equal to 50 after 14 weeks of storage of a 50 g sample of emulsion in an open container in a 35° C. incubator.

Embodiment 86. provides the emulsion of any one of Embodiments 1-85, wherein the emulsion is stable to oxidation as quantified by an anisidine value (AV) less than or equal to 10 after 14 weeks of storage of a 50 g sample of emulsion in an open container in a 35° C. incubator.

Embodiment 87. provides the emulsion of any one of Embodiments 1-86, wherein the emulsion is stable to oxidation as quantified by an anisidine value (AV) less than or equal to 100 after 12 months storage.

Embodiment 88. provides the emulsion of any one of Embodiments 1-87, wherein the emulsion is stable to oxidation as quantified by an anisidine value (AV) less than or equal to 50 after 12 months storage.

Embodiment 89. provides the emulsion of any one of Embodiments 1-88, wherein the emulsion is stable to oxidation as quantified by an anisidine value (AV) less than or equal to 10 after 12 months storage.

Embodiment 90. provides the emulsion of any one of Embodiments 1-89, wherein any antioxidants in the emulsion are plant-derived antioxidants.

Embodiment 91. provides the emulsion of any one of Embodiments 1-90, wherein any antioxidants in the emulsion are carnosic acid, carnosol, spearmint extract and components thereof, sage extract and components thereof, rosemary extract and components thereof, ascorbic acid or salts thereof, carotene or citric acid.

Embodiment 92. provides the emulsion of any one of Embodiments 1-91, wherein the emulsion consists of an oil; an oil-soluble extract comprising carnosic acid, carnosol, or a mixture thereof; an emulsifier; a colorant; a flavor; water; a water-soluble spearmint extract; water soluble ascorbic acid, or salt thereof; citric acid; and sodium chloride.

Embodiment 93. provides the emulsion of any one of Embodiments 1-92, wherein the emulsion is margarine.

Embodiment 94. provides the emulsion of any one of Embodiments 1-93, wherein the emulsion is shortening.

Embodiment 95. provides the emulsion of any one of Embodiments 1-94, wherein the emulsion is a spread.

Embodiment 96. provides the emulsion of any one of Embodiments 1-95, wherein the emulsion is substantially free of water-soluble rosemary extract.

Embodiment 97. provides the emulsion of any one of Embodiments 1-96, wherein the emulsion is substantially free of oil-soluble spearmint extract.

Embodiment 98. provides the emulsion of any one of Embodiments 1-97, wherein the emulsion has a protein content of less than 1 wt %.

Embodiment 99. provides the emulsion of any one of Embodiments 1-97, wherein the emulsion has a protein content of less than 0.5 wt %.

Embodiment 100. provides the emulsion of any one of Embodiments 1-99, wherein the emulsion has a carbohydrate content of less than 4 wt %.

Embodiment 101. provides the emulsion of any one of Embodiments 1-99, wherein the emulsion has a carbohydrate content of less than 1 wt %.

Embodiment 102. provides the emulsion of any one of Embodiments 1-101, wherein the emulsion has a fat content of at least 25 wt %.

Embodiment 103. provides the emulsion of any one of Embodiments 1-101, wherein the emulsion has a fat content of at least 50 wt %.

Embodiment 104. provides the emulsion of any one of Embodiments 1-101, wherein the emulsion has a fat content of at least 80 wt %.

Embodiment 105. provides the emulsion of any one of Embodiments 1-104, wherein rosmarinic acid is less than 0.0004 wt % of the emulsion.

Embodiment 106. provides the emulsion of any one of Embodiments 1-105, wherein rosmarinic acid is less than 0.0001 wt % of the emulsion.

Embodiment 107. provides the emulsion of any one of Embodiments 1-106, wherein rosmarinic is less than 0.00005 wt % of the emulsion.

Embodiment 108. provides the emulsion of any one of Embodiments 1-107, wherein the spearmint extract contains rosmarinic acid as predominant active ingredient.

Embodiment 109. provides the emulsion of any one of Embodiments 1-108, wherein the spearmint extract contains an amount of rosmarinic acid which accounts for more than 92% of total phenolic content of the spearmint extract.
Embodiment 110. provides an emulsion comprising:
an oil-phase comprising
an edible oil,
an emulsifier, and
an oil-soluble extract comprising carnosic acid, carnosol, or a mixture thereof; and
an aqueous-phase comprising
water,
citric acid, and
ascorbic acid, or a salt thereof;
wherein
   the oil-phase is about 80 wt % to about 87 wt % of the emulsion,
   the emulsifier is about 0.1 wt % to about 0.5 wt % of the oil-phase,
   the oil-soluble extract comprising carnosic acid, carnosol, or a mixture thereof, is about 0.005 wt % to about 0.04 wt % of the oil-phase,
   the citric acid is about 0.005 wt % to about 0.05 wt % of the aqueous-phase,
   the water-soluble spearmint extract is about 0.005 wt % to about 0.04 wt % of the aqueous-phase, and
   the ascorbic acid, or a salt thereof, is about 0.005 wt % to about 0.05 wt % of the aqueous-phase.

Embodiment 111. provides an emulsion comprising:
an oil-phase comprising an edible oil;
an aqueous-phase comprising water;
carnosic acid, carnosol, or a mixture thereof;
rosmarinic acid; and
an emulsifier, wherein the emulsion is margarine.

Embodiment 112. provides a method of preparing the emulsion of any one of Embodiments 1-111, comprising:
dissolving an emulsifier and an oil-soluble extract comprising carnosic acid, carnosol, or a mixture thereof, in an oil and heating the oil to 70° C. to form an oil-phase;
dissolving a water-soluble spearmint extract, citric acid and ascorbic acid, or salt thereof, in water and heating the water to 70° C. to form an aqueous-phase; and
emulsifying the oil-phase and the aqueous-phase together to obtain the emulsion.

Embodiment 113. provides a method of preparing the emulsion of any one of Embodiments 1-112, wherein the method comprises combining and emulsifying separately pre-mixed oil-phase and aqueous-phase, wherein
the pre-mixed oil-phase comprises the extract comprising carnosic acid, carnosol, or a mixture thereof; and
the pre-mixed aqueous-phase comprises water and the spearmint extract.

Embodiment 114. provides a method of preparing the emulsion of any one of Embodiments 1-113, wherein the emulsion was prepared by combining and emulsifying separately pre-mixed oil-phase and aqueous-phase, wherein
the pre-mixed oil-phase comprises the oil and oil-soluble components; and
the pre-mixed aqueous-phase comprises water and water-soluble components.

Embodiment 115. provides a method of preparing the emulsion of any one of Embodiments 1-114, wherein the pre-mixed oil-phase comprises the emulsifier.

Embodiment 116. provides a method of preparing the emulsion of any one of Embodiments 1-115, wherein the pre-mixed aqueous-phase comprises ascorbic acid, or a salt thereof.

Embodiment 117. provides a method of preparing the emulsion of any one of Embodiments 1-116, wherein the pre-mixed oil-phase contains colorant and flavor and the pre-mixed aqueous-phase contains citric acid and sodium chloride.

Embodiment 118. provides a method of preparing the emulsion of any one of Embodiments 1-117, wherein the emulsifier is mixed with the oil prior to contacting the aqueous-phase.

Embodiment 119. provides a method of preparing the emulsion of any one of Embodiments 1-117, wherein the emulsifier is mixed with the water prior to contacting the oil-phase.

Embodiment 120. provides a method of preparing the emulsion of any one of Embodiments 1-119, comprising heating one or both of the pre-mixed oil-phase and the pre-mixed aqueous phase to a temperature of 50° C. to 90° C. prior to combing the aqueous-phase and the oil-phase.

Embodiment 121. provides a method of preparing the emulsion of any one of Embodiments 1-120, comprising heating one or both of the pre-mixed oil-phase and the pre-mixed aqueous phase to a temperature of about 70° C. prior to combing the aqueous-phase and the oil-phase.

Embodiment 122 provides the apparatus, method, composition, or system of any one or any combination of Embodiments 1-121 optionally configured such that all elements or options recited are available to use or select from.

1. An emulsion comprising:
an oil-phase;
an aqueous-phase; and
an emulsifier;
wherein:
1) the oil-phase comprises an extract comprising carnosic acid, carnosol, or a mixture thereof; and
2) the aqueous-phase comprises an extract containing rosmarinic acid.

2. The emulsion of claim 1, wherein the extract containing rosmarinic acid is a spearmint extract.

3. The emulsion of claim 1, wherein the extract comprising carnosic acid, carnosol, or a mixture thereof, is sage extract or rosemary extract.

4. The emulsion of claim 1, wherein the extract comprising carnosic acid, carnosol, or a mixture thereof, is at about 0.005 wt % to about 0.10 wt % of the oil-phase.

5. The emulsion of claim 1, wherein the extract comprising carnosic acid, carnosol, or a mixture thereof, is about 0.01 wt % to about 0.04 wt % of the emulsion.

6. The emulsion of claim 2, wherein the spearmint extract is about 0.001 wt % to about 0.10 wt % of the aqueous-phase.

7. The emulsion of claim 2, wherein the spearmint extract is about 0.00005 wt % to about 0.0001 wt % of the emulsion.

8. The emulsion of claim 1, wherein the aqueous-phase further comprising ascorbic acid, or a salt thereof.

9. The emulsion of claim 8, wherein the ascorbic acid, or a salt thereof, is about 0.005 wt % to about 0.05 wt % of the aqueous-phase.

10. The emulsion of claim 8, wherein the ascorbic acid, or a salt thereof, is about 0.0005 wt % to about 0.005 wt % of the emulsion.

11. The emulsion of claim 1, further comprising at least one of citric acid, sodium chloride, colorant, flavoring, or a combination thereof.

12. The emulsion of claim 1, wherein the oil-phase is about 80 wt % to about 90 wt % of the emulsion.

13. The emulsion of claim 1, wherein the aqueous-phase is about 10 wt % to about 20 wt % of the emulsion.

14. The emulsion of claim 1, wherein the emulsion is stable to oxidation as defined by a peroxide value (PV) less than or equal to 5 mmol/kg after 12 months storage at room temperature.

15. The emulsion of claim 1, wherein the emulsion is stable to oxidation as defined by a peroxide value (PV) less than or equal to 5 mmol/kg after 14 weeks of storage of a 50 g sample of emulsion in an open container in a 35° C. incubator.

16. The emulsion of claim 1, wherein the emulsion is margarine.

17. An emulsion comprising:
an oil-phase that is about 80 wt % to about 87 wt % of the emulsion, comprising
an edible oil;
an emulsifier, which is about 0.1 wt % to about 0.5 wt % of the oil-phase; and
an oil-soluble extract comprising carnosic acid, carnosol, or a mixture thereof, which is about 0.005 wt % to about 0.04 wt % of the oil-phase; and
an aqueous-phase comprising
water;
an extract containing rosmarinic acid which is about 0.001 wt % to about 0.10 wt % of the aqueous-phase;
citric acid, which is about 0.005 wt % to about 0.05 wt % of the aqueous-phase; and
ascorbic acid, or a salt thereof, which is about 0.005 wt % to about 0.05 wt % of the aqueous-phase.

18. A method of preparing the emulsion of claim 17, comprising:
dissolving an emulsifier and an oil-soluble extract comprising carnosic acid, carnosol, or a mixture thereof, in an oil and heating the oil to 70° C. to form an oil-phase;
dissolving an extract containing rosmarinic acid, citric acid, and ascorbic acid or salt thereof, in water and heating the water to 70° C. to form an aqueous-phase; and
mixing the oil-phase and the aqueous-phase together to obtain the emulsion.
